(19) United States
(12) Patent Application Publication
(10) Pub. No.: US 2006/0238785 A1
(43) Pub. Date: Oct. 26, 2006

(54) Color image forming apparatus, color image forming system, color image processing method and program

(75) Inventors: Akira Maruyama, Nagano-ken (JP); Takeshi Miyashita, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/375,250

(22) Filed: Mar. 15, 2006

(30) Foreign Application Priority Data
Mar. 15, 2005 (JP) 2005-072963

(51) Int. Cl. H04N 1/60

(52) U.S. Cl. 358/1.9; 358/1.15

(57) ABSTRACT

An object of the present invention is to provide an output image with secured visibility and identification while keeping printing costs low. The procedure creates an image formation command with color conversion method information that is set as to whether to output color information for components in color or in gray scale according to image types of pixels composing color image information (step S140). This structure allows for setting as to whether to convert color information for pixels in color or in gray scale according to the types of pixels, and creation of an image formation command such as to obtain an output image where color output parts and gray-scale output parts are mixed even as a color image.

### BACKGROUND OF THE INVENTION

1. Field of the Invention

The present invention relates to a color image forming apparatus, a color image forming system, a color image processing method and program as well as an image formation command creating method and program.

2. Description of the Prior Art

When an image is formed by an image forming apparatus such as a color laser printer, for the purpose of reduction in printing costs or the like, the image is sometimes printed in gray scale at the sacrifice of visibility and clarity although it is originally a color image. An image forming apparatus for outputting, in such a case, color image data as a gray-scale image with satisfactory visibility has also been proposed in Japanese Published Unexamined Patent Application No. 2002-262108.

### SUMMARY OF THE INVENTION

However, even when such an image processing was performed, visibility and clarity of an image outputted in monochrome have not always been secured. For example, in graphs or the like, it is sometimes difficult to distinguish between the text and background and identify legends. Moreover, in a case such that an image forming apparatus is shared among a plurality of clients, it is sometimes set so that color printing is granted only to some users while only monochrome printing is granted to some other users. In such a case, there is an inconvenience such that an appropriate output image cannot be obtained unless a user to which color printing has been granted is requested to carry out printing. With such sorting by the alternative of color printing or monochrome printing, inconveniences have been unavoidable.

It is an object of the invention to provide a color image forming apparatus, a color image forming system, an image processing method, an image processing program, and an image formation command creating method and program that can provide an output image where visibility and identification are secured while keeping printing costs low, by carrying out a color/gray-scale conversion of pixel color information according to the types of pixels of image information.

In order to remove at least one of the above drawbacks, the present invention is constructed as follows.

The present invention is directed to an image forming apparatus for a color image, including: an image outputting module; and an image processing module that, when an image formation command is received, obtains color information for each of the pixels composing color image information of the received image formation command, obtains pixel type information concerning pixel types, and converts the obtained color information for each pixel into outputting color information based on, at least, the pixel type information and color conversion method information that is set as to whether to carry out a color conversion or a gray-scale conversion according to a pixel type.

In the image forming apparatus of the invention, the image processing module may set a color conversion condition for each pixel in association with the obtained color information based on the pixel type information and the color conversion method information, and forms outputting color information based on, at least, the color information for each pixel and the color conversion condition.

In the image forming apparatus of the invention, the color conversion method information may include a color conversion method that is uniquely set beforehand to a terminal from which the image formation command is received.

In the image forming apparatus of the invention, the color conversion method information may include a color conversion method that is set for each image formation command in a terminal from which the image formation command is received and is sent to the image forming apparatus together with the image formation command.

In the image forming apparatus of the invention, the pixel type information may include a character, a graphic, and an image as pixel types, and the color conversion method information may include a color conversion method for converting color information for a pixel in gray scale when the pixel type is of a character or an image while converting color information for a pixel in color when the pixel type is of a graphic.

The present invention is also directed to an image forming system for a color image, including: an image forming apparatus capable of forming a color image; a terminal that outputs an image formation command to the image forming apparatus; and an image processing module that, when an image formation command to the image forming apparatus is given by the terminal, obtains color information for each of the pixels composing color image information of the received image formation command, obtains pixel type information concerning pixel types, and converts the obtained color information for each pixel into outputting color information based on, at least, the pixel type information and color conversion method information that is set as to whether to carry out a color conversion or a gray-scale conversion according to a pixel type.

The present invention is also directed to an image processing method for a color image, including the steps of: (a) when an image formation command to an image forming apparatus capable of forming a color image is given, obtaining color information for each of the pixels composing color image information of the image formation command, and obtaining pixel type information concerning pixel types; and (b) converting the obtained color information for each pixel into outputting color information based on, at least, the pixel type information and color conversion method information that is set as to whether to carry out a color conversion or a gray-scale conversion according to a pixel type.

The present invention is also directed to a program for an image forming processing for a color image that executes the respective steps of the image forming processing method of the invention, when an image formation command to an image forming apparatus capable of forming a color image is given. This program of the invention may be recorded in a computer readable recording medium (for example, a hard disk, a ROM, an FD, a CD, a DVD, or a chip), may be transferred from one computer to another computer via a transfer medium (a communication network like the Internet or a LAN) or may be transmitted in any other suitable form. The program may be a printer drive program.

The present invention is further directed to a method for creating an image formation command to an image forming apparatus capable of forming a color image, including the steps of: creating an image formation command including color conversion method information that is set as to whether to convert color information for components in color or in gray scale according to types of pixels included in color image information of an image formation command to the image forming apparatus.

The method for creating an image formation command of the invention may further includes the step of setting the color conversion method in the color conversion method information for each image formation command to the image forming apparatus.

The present invention is further directed to a program for creating an image formation command that executes the respective steps of the method for creating an image formation command of the invention. This program of the invention may be recorded in a computer readable recording medium (for example, a hard disk, a ROM, an FD, a CD, a DVD, or a chip), may be transferred from one computer to another computer via a transfer medium (a communication network like the Internet or a LAN), or may be transmitted in any other suitable form. The program may be a printer drive program.

### BRIEF DESCRIPTION OF THE DRAWINGS

FIG. 1 is a view showing a schematic configuration of an image forming system;

FIG. 2 is a view showing a schematic configuration of a color laser printer;

FIG. 3 is a block diagram showing input and output of a control signal in a controller 60;

FIG. 4 is a flowchart showing a print command creation process;

FIG. 5 shows an example of a print command creation screen;

FIG. 6 is a flowchart showing a color image process;

FIG. 7 is a flowchart showing a RGBX band preparation process; and

FIG. 8 is a flowchart showing a drawing process.

### DETAILED DESCRIPTION OF THE PREFERRED EMBODIMENT

An embodiment of the present invention will now be described.

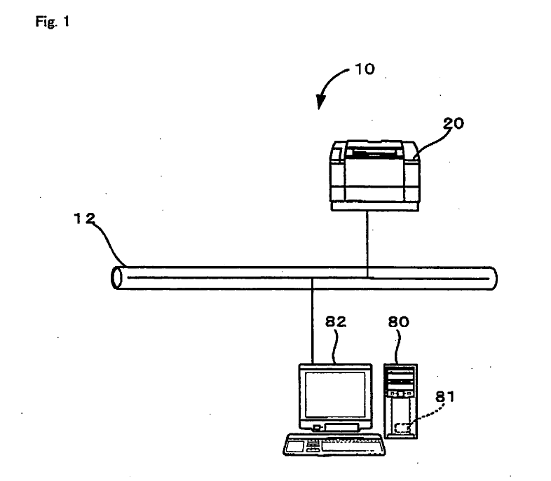

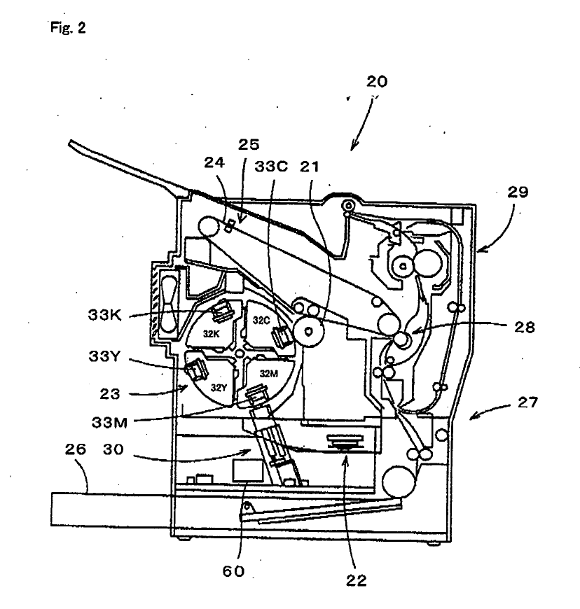

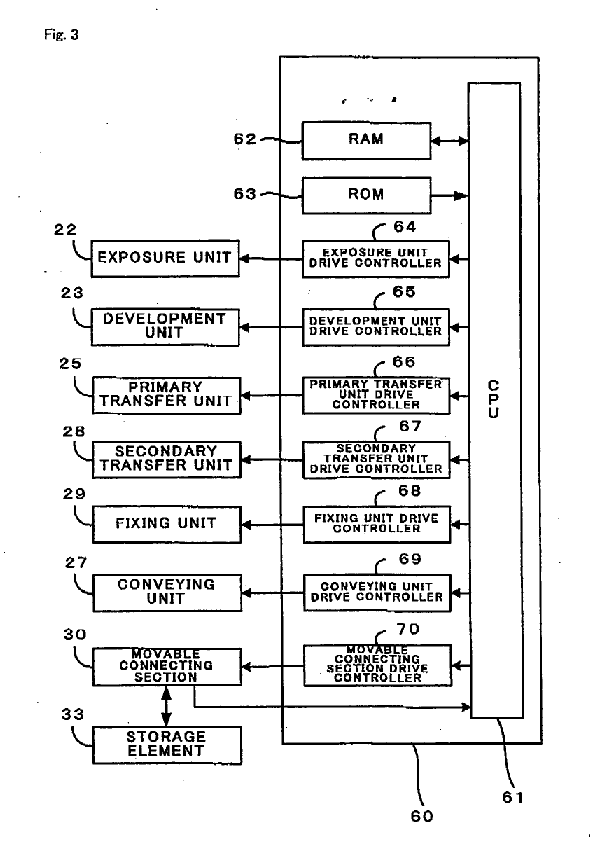

FIG. 1 is a view showing a schematic configuration of an image forming system to which the present invention is applicable, FIG. 2 is a view showing a schematic configuration of a color laser printer 20 as an image forming apparatus, and FIG. 3 is a block diagram showing input and output of a control signal in a controller 60 of the color laser printer 20. An image forming system 10 of the embodiment includes, as shown in FIG. 1, a color laser printer 20 that is connected to a LAN (Local Area Network) and functions as an image forming apparatus and a client 80 provided with a display 82 that displays a print command creation screen when an instruction on a print command creation is given in various applications.

The color laser printer 20 is constructed as a full-color electrophotography printing apparatus employing a single-photoconductor system and an intermediate transfer system. The color laser printer 20 includes, as exemplified in FIG. 2, an exposure unit 22 that irradiates laser light onto a photoconductor 21 charged with images in respective colors separated into four colors of cyan (C), magenta (M), yellow (Y), and black (K) and forms those as electrostatic latent images, a development device 23 that develops the electrostatic latent images formed on the photoconductor 21 as toner images by use of respective color toners supplied from attached various color toner cartridges 32C, 32M, 32Y, and 32K, a primary transfer unit 25 that transfers the respective color toner images developed on the photoconductor 21 onto a transfer belt 24 in an overlapping manner to form a color toner image, a conveying unit 27 that conveys paper from a paper cassette 26, a secondary transfer unit 28 that transfers the color toner images formed on the transfer belt 24 onto the conveyed paper, a fixing unit 29 that fixes the transferred color toner images to the paper by fusion bonding and discharges the paper, a movable connecting section 30 that connects with storage elements 33C, 33M, 33Y, and 33K (hereinafter, referred to simply as 33C to 33K) attached to the toner cartridges 32C, 32M, 32Y, and 32K (hereinafter, referred to simply as 32C to 32K) as a result of a rotation of the development unit 23 and reads identification information such as serial numbers unique to the storage elements 33C to 33K and information concerning toner colors into the cartridges, and a controller 60 that controls operation of the color laser printer 20 as a whole. Here, the storage elements 33 included in the cartridges 32 are constructed as ASICs or CSICs. The color laser printer 20 includes an unillustrated LAN board so as to function as a network printer. Here, although a printing apparatus employing a single-photoconductor method and an intermediate transfer method has been described in the embodiment, it may be of another construction such as a tandem system having a photoconductor and a development device for each color.

The controller 60 is, as shown in FIG. 3, constructed as a microprocessor composed mainly of a CPU 61, a RAM 62, a ROM 63, and the like, into which values detected by various sensors (for example, various temperature sensors to detect a fixing roller temperature of the fixing unit 29 and an ambient temperature in the vicinity thereof) and other input signals (for example, a print command signal by a user and the like) are inputted via signal lines. The controller 60 controls, based on these input signals, operations of respective sections of the color laser printer 20, such as the exposure unit 22, development unit 23, primary transfer unit 25, secondary transfer unit 28, fixing unit 29, conveying unit 27, and movable connecting section 30, via an exposure unit drive controller 64, a development device drive controller 65, a primary transfer unit drive controller 66, a secondary transfer unit drive controller 67, a fixing unit drive controller 68, a conveying unit drive controller 69, a movable connecting section drive controller 70, and the like.

In the RAM 62, programs and data for various processings are read in. For example, various types of information for a color image processing program stored in the ROM 63 and the cartridges 32C to 32K stored in the storage elements 33 are also read into the RAM 62 by an initial operation when the printer 20 is powered on. Also, in the RAM 62, a region for storing color conversion method information that is required to execute a color image processing program and a region for a band buffer necessary for a banding process and a frame memory are secured.

The ROM 63 stores a program for executing a print command by controlling respective sections of the printer 20 as well as an image processing program and data for executing respective processings of an intermediate code preparation, banding, and drawing upon an image formation command from the client 80.

The client 80 is connected to the display 82 as a screen display unit and has an unillustrated controller. The client 80 is connected to the color laser printer 20 and is capable of outputting a print command to the color laser printer 20 via the LAN 12. In the client 80, a program for creating a print command capable of instructing the printer to execute color printing according to the types of pixels when creating a color image formation command is installed.

Next, operations of the color laser printer 20 of the embodiment constructed as above, in particular, operations when making the color laser printer 20 print an original color copy where character data, graphic data, and image data are mixed with only the graphics in color will be described. For convenience of description, description will be given of a print command creation process in the client 80, and then description will be given of an image processing in the color laser printer 20.

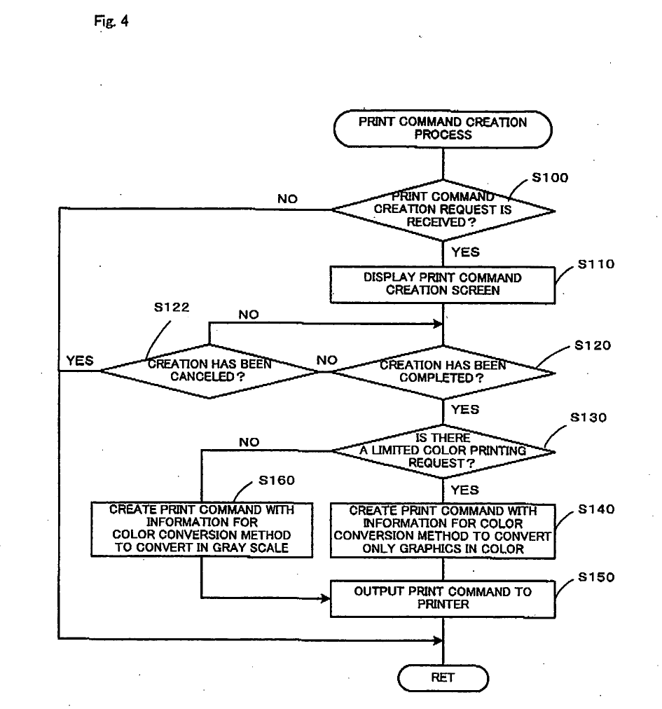

FIG. 4 is a flowchart showing an example of a print command creation process executed by a controller 81 of the client 80. The print command creation process is executed by the controller 81 at every fixed time, and can thus display a predetermined print command creation screen to create a print command when a print command creation request has been detected.

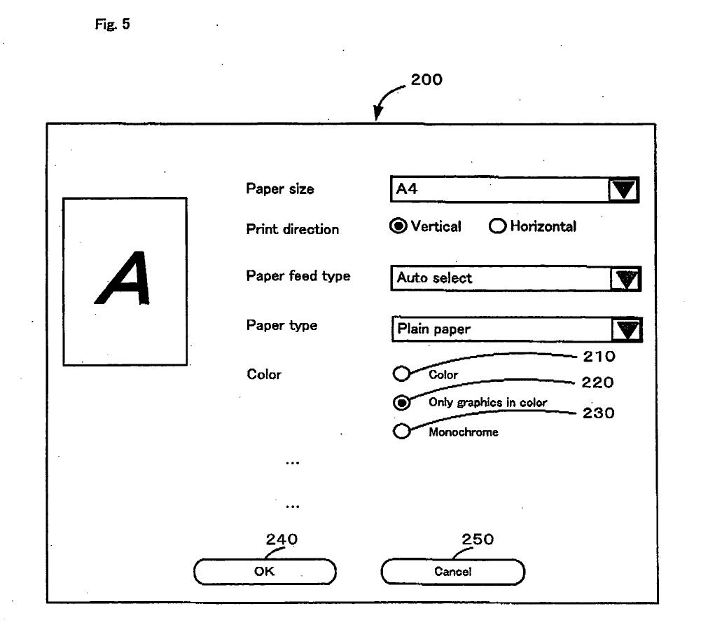

In the print command creation process, first, as illustrated, the controller 81 monitors as to whether there is a print command creation request (step S100). When the request is not detected, the controller ends the print command creation process. When the print command creation request has been detected, on the other hand, the controller displays a print command creation screen 200 exemplified in FIG. 5 (step S110).

As shown in FIG. 5, the print command creation screen 200 includes various selection buttons as well as a selection button 210 for selecting color printing, a selection button 220 for selecting color printing only for graphics, and a selection button 230 for selecting monochrome printing. The selection button 210 means to print all objects of color image information to be printed, in color. The selection button 220 means to print only graphics such as graphs of various objects of color image information in color and print characters and images in gray scale. Namely, the selection button 220 intends a limited color printing. Such a color printing method intended by the selection button 220 corresponds to a color conversion method of the present invention.

Here, the selection button 210 for selecting color printing is set unselectable since a user of the client 80 of the present embodiment is not permitted to execute color printing using the color laser printer 20. On the other hand, the selection button 220 for printing only graphics in color and the selection button 230 for monochrome printing are set selectable by the user of the client 80. Accordingly, when the user has selected the selection button 210 in the print command creation screen 200, such a display screen as “It cannot be selected. Please select another color.” is displayed. In the following process, description will be given mainly of when the user has selected the selection button 220. Here, such a limitation for a user on color printing can be realized by a printer driver program.

The controller 81 monitors as to whether a selection button 240 for completing print command creation has been operated (step S120) by the user in the print command creation screen 200. The controller ends the print command creation process when a selection button 250 for canceling print command creation has been selected (S122). When completion of the creation has been detected, on the other hand, the controller subsequently judges as to whether a limited color printing is requested as a result of selection of the selection button 220 (step S130).

When a limited color printing is request, the client 80 creates a print command including information for a color conversion method to print only graphics in color, that is, to carry out a color conversion to CMYK color information for the pixel of graphic while carrying out a gray-scale conversion to gray-scale color information for the pixel of a character or an image (step S140), and outputs the created print command to the color laser printer 20 (step S150). On the other hand, when the selection button 220 has not been selected but the selection button 230 has been selected, the client 80 creates a print command including information for a color conversion method to carry out a color conversion in gray scale for all objects assuming that there is no limited color printing request (step S160), and outputs the created print command to the color laser printer 20 (step S150).

The print command thus created already includes various types of color conversion information for a color conversion method and color correction, and information as to whether respective objects included in image information are characters, graphics, or images, as well as color information in RGB and attributes such as pixel types in pixel units.

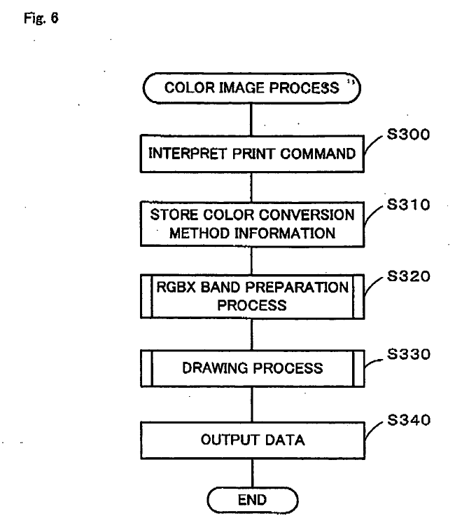

Next, an image process in the color laser printer 20 that has received a print command will be described. FIG. 6 is a flowchart showing an example of an image process executed by the controller 60 of the color laser printer 20. The image process is executed when the controller 60 has received a print command from the client 80.

First, the controller 60 carries out a command interpretation for the print command and converts the print command to a code in an intermediate form (step S300). The command interpretation is carried out for each page of received image information. Here, color conversion method information and other information included in the print command are also interpreted.

After the print command has been converted to a code in an intermediate form suitable for a processing in the color laser printer 20, the controller 60 interprets the color conversion method information based on the intermediate code and stores the same in the RAM 62 (step S310). In this embodiment, a color conversion method, which carries out a color conversion to CMYK color information only for the pixel of a graphic while carrying out a gray-scale conversion to gray-scale color information for the pixel of a character or an image, is stored in the color conversion method information storing region that has been allocated to the RAM 62 beforehand.

In the image process, the controller 60 subsequently prepares an RGBX band (step S320). The RGBX band is a group of RGBX data for each pixel. A process of preparing the RGBX band divides one page of image information into some number of horizontal band units and accumulates RGBX data for each divided band unit. Such a banding process is performed to smoothly carry out a subsequent drawing process where the drawing is carried out by the band unit. In this embodiment, the RGBX band is prepared in a predetermined region on the RAM 62.

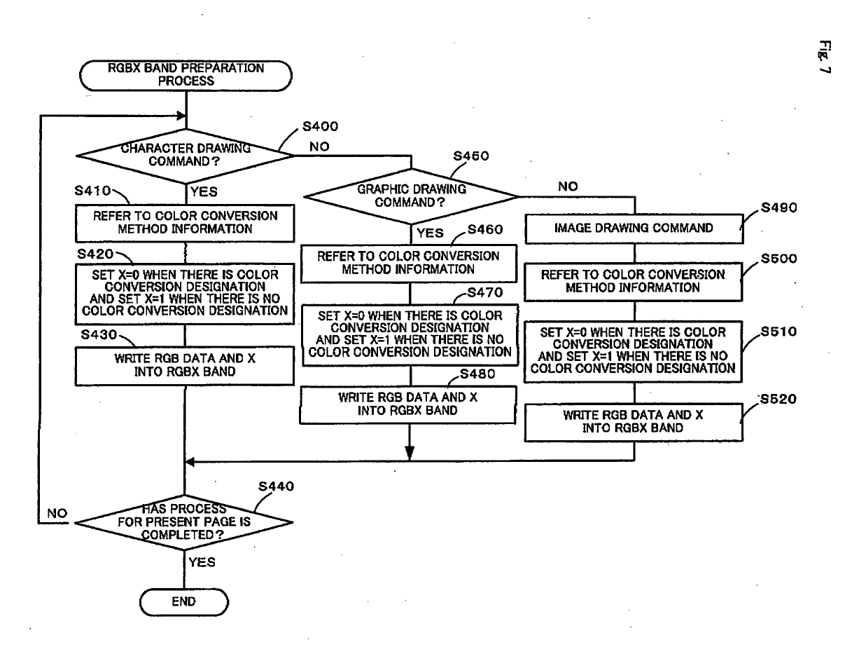

FIG. 7 shows an example of a flowchart of the RGBX band preparation process. In the flowchart, a page-by-page processing of image information is shown. The procedure of the RGBX and preparation process first interprets a command based on the intermediate code to judge as to whether it is a character drawing command (step S400). When it is a character drawing command, the procedure further judges there is a color conversion with reference to a color conversion method of the color conversion method information stored in the RAM 62 when the pixel type is of a character (step S410). Then, the procedure sets a color conversion condition (color conversion condition flag) so as to provide X=0 when a color conversion is carried out and provide X=1 when no color conversion is carried out (when a gray-scale conversion is carried out) (step S420). In this embodiment, since a color conversion condition that no color conversion is carried out for the pixel of a character has been provided, the procedure sets 1 to X and write the X-channel data as a color conversion condition along with RGB data that has been separately obtained, into a predetermined memory cell allocated for each pixel in the RGBX band (step S430).

When the drawing command is not a character drawing command, the procedure judges whether it is a graphic drawing command (step S450). When it is a graphic drawing command, the procedure confirms a color conversion condition, with reference to the color conversion method information storing region of the RAM 62 as in the foregoing (step S460), and set 1 or 0 to X data so as to set a color conversion condition (step S470). In this embodiment, since a color conversion method to carry out a color conversion for a graphic pixel has been provided, the procedure sets 0 to X and writes the X-channel data as a color conversion condition along with RGB data, into a predetermined memory cell of the RGBX band along with ROB data (S480).

When it is judged in step S450 that the drawing command is not a graphic drawing command either, the procedure assumes that it is an image drawing command (step S490), refers to the color conversion method information storing region of the RAM 62 in the same manner as in the foregoing (step S500), judges a color conversion method to form X data as a color conversion condition (S510), and writes RGB data and the color conversion condition into a predetermined memory cell of the RGBX band (step S520).

In such a manner, RGBX data composed of RGB data and X data as a color conversion condition is prepared from a drawing command for each pixel and is written into an RGBX band sequentially. When each one band of RGBX data has been prepared (step S440), the RGBX data preparation process corresponding to the band is ended, and such an RGBX data process for each band is continuously carried out.

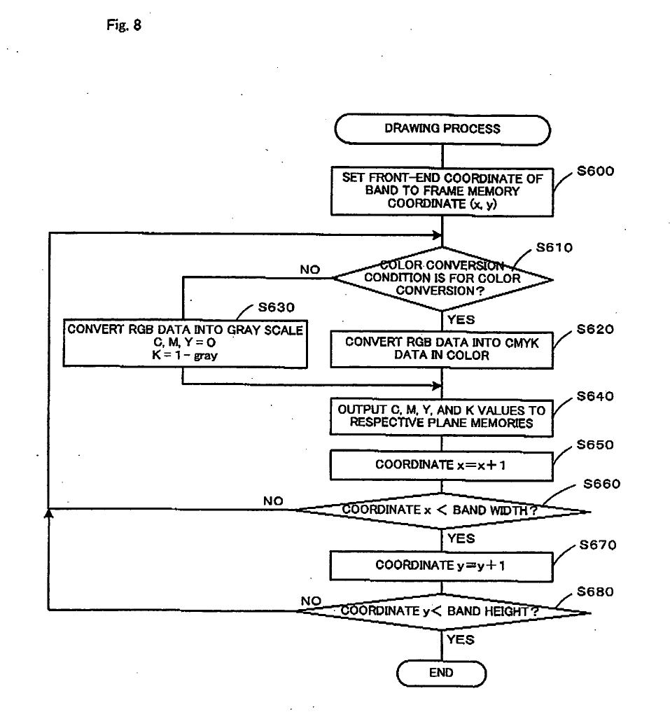

When RGBX data in band units has been prepared for one page, the controller 60 carries out a drawing process using that RGBX data sequentially (FIG. 6, step S330). The drawing process is carried out in band units, referring to RGBX bands prepared in the RAM 62. FIG. 8 shows an example of a flowchart of the drawing process. In the drawing process, drawing proceeds from the front-end position of a band in the X-direction, for which with reference to the RGBX band for each pixel, RGB data is color-converted based on X data to outputting CMYK data.

The procedure of the drawing process first sets a coordinate on the frame memory to the front-end coordinate of a band (step S600). The procedure then refers to X data on the RGBX band with regard to the first pixel, and judges whether the X data is 0, in other words, whether a color conversion has been set as a color conversion condition (step S610). When it is judged that the X data is 0 and a color conversion has been set as a color conversion condition, the procedure converts RGB data of the RGBX band for that pixel into CMYK data (step S620). When the X data is 1 and a gray-scale conversion has been set as a color conversion condition, on the other hand, the procedure executes a gray-scale conversion from RGB data according to a predetermined converting method to obtain CMYK data (step S630). Here, respective CMY values obtained as a result of the gray-scale conversion is 0.

The procedure subsequently outputs the obtained CMYK data to respective color plane memories of a C plane, an K plane, a Y plane, and a K plane, respectively (step S640). Such a CMYK conversion for each pixel is sequentially carried out in the X-direction, and when the CMYK conversion is completed for the X end of the band (step S650, step S660), the procedure carries out a similar CMYK conversion for the following Y-coordinate pixels (step S670, step S610 to step S660).

When sequential processing is proceeded as such for each pixel to process the whole up to the band height (step S680), the procedure ends the drawing process on the band. Upon obtaining RGBX data on a next band, the controller 60 re-executes a drawing process on that band (step S330).

After ending the drawing process in band units, the controller 60 outputs the data to the image forming units of the color laser printer 20 as raster data (step S340). When all data on the respective CMY planes are 0, the respective units are set to a monochrome printing mode, and when not, to a color printing mode. According to such a color image forming process, an image outputted onto a recording medium such as paper results in that a graphic region is outputted in color, while a character region and an image region are outputted in gray scale.

According to the embodiment of the present invention described above, whether to convert information thereon in color or in gray scale is set according to a pixel type, and even as a color image, an output image composed of a color output part and a gray-scale output part can be obtained. In such an output image, visibility and clarity of the image can be secured by existence of the color output part, and image forming costs are kept low by existence of the gray scale output part. Accordingly, even when a user desires to limit outputting a color image in color to reduce printing costs or when a user desires to avoid outputting a color image in color for any reason, visibility and clarity of an output document can be secured while printing costs are kept low.

Moreover, according to the embodiment of the present invention, a color conversion condition as to whether to convert color information for each pixel in color or in gray scale is stored beforehand in the X-channel of RGBX data for each pixel in the RGBX data preparation processing (step S320), and after that the drawing process is carried out based on this RGBX data (step S330) to form outputting CMYK data. The drawing process can thus be executed efficiently or swiftly, and carrying out such a preprocessing prior to the drawing process is suitable for a banding process as well.

Furthermore, according to the embodiment of the present invention, a color conversion method when setting the color conversion condition for each pixel has been set for the client 80 beforehand. Namely, in the print command creation screen 200 for the color laser printer 20, only the selection button 220 for “only graphics in color” is prepared as a selection button for a mixed image. Accordingly, the user can obtain an output image while keeping image forming costs low and achieving high visibility when, for example, printing costs must be kept low although a document containing many graphics has been prepared in the client 80.

Still furthermore, according to the embodiment of the present invention, the color conversion method has been set so as to print only graphics in color and carry out a gray-scale conversion for the pixel of a character or an image. According to such a setting of the color conversion method, since image information that is relatively high in requirement such as visibility is color-converted, this is useful for preparing a document that does not contain many images or that is relatively low in significance of images. For example, in ordinary offices, such a color conversion method is suitable for preparing a document containing a lot of graphic data.

In the present embodiment, the printer 20 corresponds to the image forming apparatus of the invention, the various image forming units in the printer 20 correspond to image outputting modules, and the controller 60 and CPU 61 that carries out the color image forming process (FIG. 6, step S300 to step S330) corresponds to an image processing module of the invention. In addition, the client 80 that transmits a print command to the printer 20 corresponds to a terminal that outputs an image formation command to the image forming apparatus, and a network 10 including the printer 20 and the client 80 corresponds to the image forming system.

In the embodiment described above, the color conversion method according to the types of pixels is inherent to the client 80 and cannot be set by a user. In one modified structure, a user may freely set a color conversion method every time to create a print command. For example, the client 80 in the above embodiment, “only graphics in color” can be selected for the color conversion method. It is also possible to provide options like “only characters in color” when the user wants to output characters in color to make a highlighted part and the like conspicuous, or “only images in color” when visibility and clarity of images such as photos are important, for the color conversion method. This structure allows creating an image formation command such as to output a color/gray-scale mixed image according to the types of images to be outputted and according to the user's convenience. Here, even in the case where a user is permitted to set color output for each pixel as such, by providing a setting in a printer driver program so as not to permit a setting for color output on all pixels (so-called normal color output), an output document with secured visibility and clarity can be obtained according to the types of images to be outputted, the user's convenience, and other circumstances, while printing costs are kept low.

In the present embodiment, RGBX data bands are formed to carry out drawing in band units. Without limitation hereto, it is also possible to carry out such a processing in page units. Moreover, in the present embodiment, color conversion information is stored in the X-channel of RGBX data. In one structure, not only the color conversion information but also other information concerning pixel attributes, color correction, and the like contained in a creation command outputted from the client 80 may be stored in the X-channel to carry out a conversion processing from RGB data to CMYK data based on the information,

In the present embodiment, a pixel-by-pixel color conversion condition is set for each pixel (in the X-channel) beforehand before a conversion from RGB data to CMYK data. In one modified structure, a color conversion may be carried out at a conversion to CMYK data with reference to color conversion method information stored in the RAM 62 for each pixel. In particular, a low-resolution printer 20 may employ such a drawing process.

In the present embodiment, an image process is executed in the printer 20. however, The image process may be executed in the client 80 by a printer drive program installed in the client 80.

Moreover, in the present embodiment, the color laser printer 20 is used as a printing apparatus. The printing apparatus may be various types of printers such as a monochrome laser printer and an ink jet printer, and may be a printing apparatus other than a printer such as a fax and a copier and a multifunction device.

In the present embodiment, the present invention is described in the mode of a color image forming system using the color laser printer 20 as an image forming apparatus. The present invention may be in the mode of a color image forming apparatus, a color image processing method, and a color image processing program.

Furthermore, the print command creation process in the present embodiment may be in the mode of a print command creating method, a print command creating program, and the like.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The present invention claims the benefit of priority from Japanese Patent Application No. 2005-072963 filed on Mar. 15, 2005, the entire contents of which are incorporated herein by reference.

What is claimed is:

1. An image forming apparatus for a color image, comprising:
an image outputting module; and
an image processing module that, when an image formation command is received, obtains color information for each of the pixels composing color image information of the received image formation command, obtains pixel type information concerning pixel types for each of the pixels, and converts the obtained color information for each pixel into outputting color information based on, at least, the pixel type information and color conversion method information that is set as to whether to carry out a color conversion or a gray-scale conversion according to a pixel type.

2. The image forming apparatus according to claim 1, wherein
the image processing module sets a color conversion condition for each pixel in association with the obtained color information based on the pixel type information and the color conversion method information, and forms outputting color information based on, at least, the color information for each pixel and the color conversion condition.

3. The image forming apparatus according to claim 1, wherein
the color conversion method information includes a color conversion method that is uniquely set beforehand to a terminal from which the image formation command is received.

4. The image forming apparatus according to claim 1, wherein
the color conversion method information includes a color conversion method that is set for each image formation command in a terminal from which the image formation command is received and is sent to the image forming apparatus together with the image formation command.

5. The image forming apparatus according to claim 1, wherein
the pixel type information includes a character, a graphic, and an image as pixel types, and the color conversion method information includes a color conversion method for converting color information for a pixel in gray scale when the pixel type is of a character or an image while converting color information for a pixel in color when the pixel type is of a graphic.

6. An image forming system for a color image, comprising:
an image forming apparatus capable of forming a color image;
a terminal that outputs an image formation command to the image forming apparatus; and
an image processing module that, when an image formation command to the image forming apparatus is given by the terminal, obtains color information for each of the pixels composing color image information of the received image formation command, obtains pixel type information concerning pixel types, and converts the obtained color information for each pixel into outputting color information based on, at least, the pixel type information and color conversion method information that is set as to whether to carry out a color conversion or a gray-scale conversion according to a pixel type.

7. An image processing method for a color image, comprising the steps of:
(a) when an image formation command to an image forming apparatus capable of forming a color image is given, obtaining color information for each of the pixels composing color image information of the image formation command, and obtaining pixel type information concerning pixel types for each of the pixels; and
(b) converting the obtained color information for each pixel into outputting color information based on, at least, the pixel type information and color conversion method information that is set as to whether to carry out a color conversion or a gray-scale conversion according to a pixel type.

8. A program for an image forming processing for a color image that causes a computer to execute the respective steps as set forth in claim 7, when an image formation command to an image forming apparatus capable of forming a color image is given.

9. A method for creating an image formation command to an image forming apparatus capable of forming a color image, comprising the steps of:
creating an image formation command including color conversion method information that is set as to whether to convert color information for components in color or in gray scale according to types of pixels included in color image information of an image formation command to the image forming apparatus.

10. The method according to claim 9, further comprising the step of setting the color conversion method in the color conversion method information for each image formation command to the image forming apparatus.

11. A program for creating an image formation command that causes a computer to execute the respective steps as set forth in claim 9 or 10.
